(19) United States
(12) Patent Application Publication
(10) Pub. No.: US 2024/0253453 A1
(43) Pub. Date: Aug. 1, 2024

(54) COOLING MODULE FOR AN ELECTRIC OR HYBRID MOTOR VEHICLE, HAVING A VARIABLE-VOLUTE, TANGENTIAL-FLOW TURBOMACHINE

(71) Applicant: VALEO SYSTEMES THERMIQUES, La Verriere (FR)

(72) Inventors: Amrid MAMMERI, La Verriere (FR); Kamel AZZOUZ, La Verriere (FR); Sebastien GARNIER, La Verriere (FR); Issiaka TRAORE, La Verriere (FR)

(73) Assignee: VALEO SYSTEMES THERMIQUES, La Verriere (FR)

(21) Appl. No.: 18/566,756

(22) PCT Filed: Jun. 3, 2022
(86) PCT No.: PCT/EP2022/065200

§ 371 Date: Dec. 4, 2023

(30) Foreign Application Priority Data
Jun. 3, 2021 (FR) FR2105851

(51) Int. Cl. B60K 11/08; F01P 5/06; F01P 11/10

(52) U.S. Cl. CPC B60K 11/08; F01P 5/06; F01P 11/10; F01P 2050/24

(57) ABSTRACT

A cooling module for an electric or hybrid motor vehicle, intended to have an air flow passing through it and including: a fairing forming an internal channel through which the air flow passes between an upstream end and a downstream end opposite each other, the fairing including at least one heat exchanger, a first collector housing arranged downstream of the fairing in a longitudinal direction of the cooling module from a front to a rear of the cooling module, the first collector housing including a tangential-flow turbomachine configured so as to generate the air flow, the tangential-flow turbomachine including a blower housing with an outlet for the air flow. The blower housing includes an outer wall which is movable between a first end position in which the outlet has a first orientation, and a second end position in which the outlet has a second orientation different from the first orientation.

### TECHNICAL FIELD

The present invention relates to a cooling module for an electric or hybrid motor vehicle, having a tangential-flow turbomachine.

### BACKGROUND OF THE INVENTION

A cooling module (or heat exchange module) of a motor vehicle conventionally comprises at least one heat exchanger and a ventilation device which is designed to generate an air flow in contact with the at least one heat exchanger. The ventilation device thus makes it possible, for example, to generate an air flow in contact with the heat exchanger when the vehicle is stationary or running at low speed.

Conventionally, the heat exchanger is then placed in a compartment facing at least two cooling openings formed in the front face of the body of the motor vehicle. A first cooling opening is located above the bumper while a second opening is located below the bumper. Such a configuration is preferred since the combustion engine must also be supplied with air, the air intake of the engine conventionally being located in the passage of the air flow passing through the upper cooling opening.

Depending on the different vehicles, this compartment can be reduced in size to a greater or lesser extent and obstacles can be present at the rear of the cooling module which hinder the discharge of the air flow passing through it. This is particularly the case when the air flow is generated by the ventilation device. It is therefore necessary to increase the size and/or power of this ventilation device so that the air flow is sufficient for heat exchange to take place correctly at the heat exchanger(s). This is not the most optimal solution, as it consumes a lot of energy and can reduce the range of the electric or hybrid vehicle.

### SUMMARY OF THE INVENTION

The object of the present invention is thus to eliminate the disadvantages of the prior art at least partly, and to propose an improved cooling module which permits optimal performance levels whilst limiting its energy consumption.

The present invention therefore relates to a cooling module for an electric or hybrid motor vehicle, said cooling module being intended to have an air flow passing through it and having:
a fairing forming an internal channel through which the air flow passes between an upstream end and a downstream end opposite each other, said fairing comprising at least one heat exchanger,
a first collector housing arranged downstream of the fairing in a longitudinal direction of the cooling module from the front to the rear of said cooling module, said first collector housing comprising a tangential-flow turbomachine configured so as to generate said air flow, said tangential-flow turbomachine comprising a blower housing including an outlet for the air flow,
the blower housing comprising an outer wall which is movable between a first end position in which the outlet of the air flow has a first orientation, and a second end position in which the outlet of the air flow has a second orientation different from the first orientation.

According to one aspect of the invention, the outer wall is sliding.

According to another aspect of the invention, the cooling module comprises a winding shaft around which the outer wall winds, said winding shaft being fixed at the end of the outer wall opposite its end forming the outlet.

According to another aspect of the invention, the winding shaft is motorised.

According to another aspect of the invention, the cooling module comprises lateral rails for guiding the outer wall.

According to another aspect of the invention, in the first end position of the outer wall of the blower housing, the first orientation of the outlet of the air flow is perpendicular to the longitudinal direction of the cooling module.

According to another aspect of the invention, in the second end position of the outer wall of the blower housing, the second orientation of the outlet of the air flow is opposite the first orientation of said outlet relative to the longitudinal direction of the cooling module.

According to another aspect of the invention, when the outer wall of the blower housing is arranged in an intermediate position between its first and second end positions, the outlet of the air flow is oriented in an intermediate orientation between the first and second orientations.

According to another aspect of the invention, the outer wall of the blower housing comprises a succession of articulated, mutually parallel slats.

According to another aspect of the invention, the outer wall of the blower housing is a semi-rigid sheet impermeable to air.

### SUMMARY OF THE INVENTION

Further features and advantages of the present invention will become more clearly apparent from reading the following description, which is given by way of non-limiting illustration, and with reference to the accompanying drawings, in which:

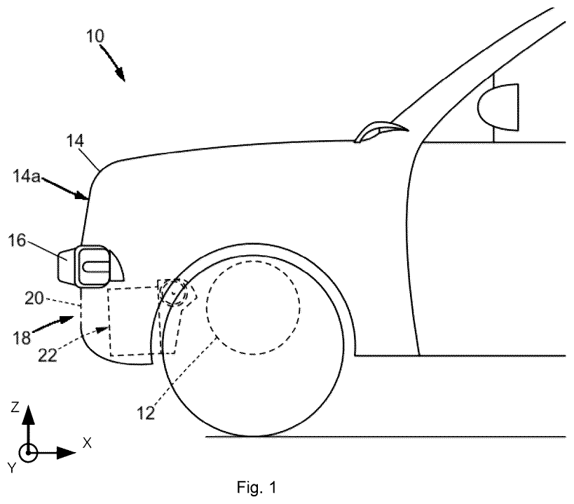

FIG. 1 shows a schematic depiction of the front of a motor vehicle in side view;

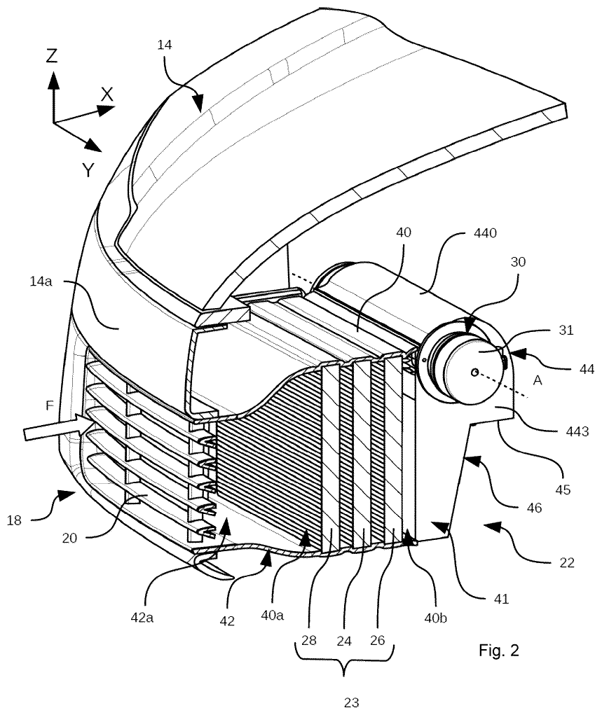

FIG. 2 shows a schematic perspective depiction, in partial cross section, of the front of a motor vehicle and of a cooling module,

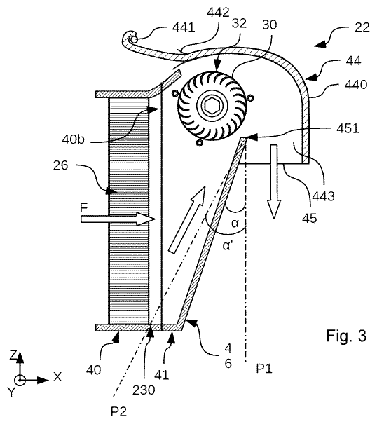

FIG. 3 shows a schematic representation, in cross-section of a first collector, of an outer wall in a first end position,

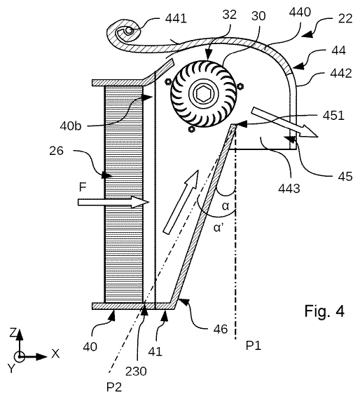

FIG. 4 shows a schematic representation, in cross-section of a first collector, of an outer wall in an intermediate position, and

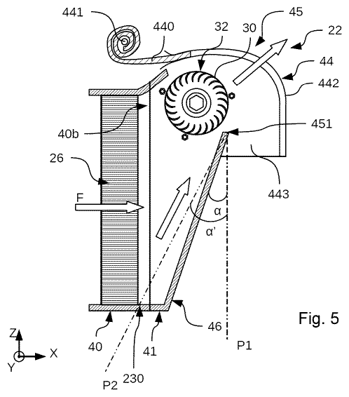

FIG. 5 shows a schematic representation, in cross-section of a first collector, of an outer wall in a second end position.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Single characteristics of different embodiments can also be combined and/or interchanged to provide other embodiments.

In the present description, certain elements or parameters can be indexed, for example first element or second element and also first parameter and second parameter or first criterion and second criterion, etc. In this case, this is simply indexing to differentiate and designate elements or parameters or criteria that are similar but not identical. This indexing does not imply a priority of one element, parameter or criterion over another and such denominations can be easily interchanged without departing from the scope of the present description. Neither does this indexing imply any chronological order for example in assessing any given criterion.

In the present description, “upstream” is intended to mean that an element is placed before another with respect to the direction of circulation of the air flow. By contrast, “downstream” is intended to mean that an element is placed after another with respect to the direction of circulation of the air flow.

FIGS. 1 to 5 show a trihedron XYZ to define the orientation of the various elements in relation to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

In FIGS. 1 and 2, the cooling module according to the present invention is illustrated in a functional position, that is to say when it is disposed within a motor vehicle.

FIG. 1 illustrates schematically the front part of an electric or hybrid motor vehicle 10 which can comprise an electric motor 12. The vehicle 10 comprises in particular a body 14 and a bumper 16 carried by a chassis (not shown) of the motor vehicle 10. The body 14 defines a cooling opening 18, i.e. an opening through the body 14. In this case, there is only one cooling opening 18. This cooling opening 18 is preferably in the lower part of the front face 14a of the body 14. In the example illustrated, the cooling opening 18 is situated below the bumper 16. A grille 20 can be positioned in the cooling opening 18 to prevent projectiles from being able to pass through the cooling opening 18. A cooling module 22 is positioned facing the cooling opening 18. The grille 20 in particular provides protection for the cooling module 22.

As shown in FIG. 2, the cooling module 22 is designed to have an air flow F passing through it parallel to the direction X, and going from the front to the rear of the vehicle 10. This direction X more particularly corresponds to a longitudinal direction X and extending from the front toward the rear of the cooling module 22. In the present application, an element which is positioned further forward or rearward than another element is referred to respectively as being “upstream” or “downstream”, in the longitudinal direction X of the cooling module 22. The front corresponds to the front of the motor vehicle 10 in the mounted state, or to the face of the cooling module 22 through which the air flow F is intended to enter the cooling module 22. The rear, for its part, corresponds to the rear of the motor vehicle 10, or to the face of the cooling module 22 via which the air flow F is intended to exit from the cooling module 22.

The cooling module 22 essentially has a housing or fairing 40 forming an internal channel between an upstream end 40a and a downstream end 40b, which are opposite to one another. At least one heat exchanger 24, 26, 28 is positioned inside said fairing 40. This internal channel is preferably oriented parallel to the longitudinal direction X such that the upstream end 40a is oriented toward the front of the vehicle 10, facing the cooling opening 18, and such that the downstream end 40b is oriented toward the rear of the vehicle 10. In FIG. 2, the cooling module 22 comprises three heat exchangers 24, 26, 28 grouped together within a heat exchanger assembly 23. However, it could comprise more or fewer depending on the desired configuration.

A first heat exchanger 24 can for example be designed to release heat energy from the air flow F. This first heat exchanger 24 can more specifically be a condenser connected to a cooling circuit (not shown), for example to cool the batteries of the vehicle 10. This cooling circuit can for example be an air-conditioning circuit able to cool the batteries and an internal air flow destined for the motor vehicle interior.

A second heat exchanger 26 can also be designed to release heat energy into the air flow F. This second heat exchanger 26 can more specifically be a radiator connected to a heat control circuit (not shown) for electrical elements, such as the electric motor 12.

Since the first heat exchanger 24 is generally a condenser of an air-conditioning circuit, the latter needs the air flow F to be as “cool” as possible in air-conditioning mode. For this purpose, the second heat exchanger 26 is preferably positioned downstream from the first heat exchanger 24 in the longitudinal direction X of the cooling module 22. It is nevertheless entirely conceivable for the second heat exchanger 26 to be positioned upstream from the first heat exchanger 24.

The third heat exchanger 28 can itself also be configured to release heat energy into the air flow. This third heat exchanger 28 can more particularly be a radiator connected to a thermal management circuit (not shown), which can be separate from the one connected to the second heat exchanger 26, for electrical elements such as the power electronics. It is also entirely conceivable for the second 26 and the third 28 heat exchangers to be connected to a single thermal management circuit, for example connected in parallel with one another.

Again according to the example illustrated in FIG. 2, the second heat exchanger 26 is positioned downstream from the first heat exchanger 24, whereas the third heat exchanger 28 is positioned upstream from the first heat exchanger 24. Other configurations can nevertheless be envisaged, such as, for example, the second 26 and third 28 heat exchangers both being positioned downstream or upstream from the first heat exchanger 24.

In the embodiment illustrated, each of the heat exchangers 24, 26, 28 has a generally parallelepipedic form which is determined by a length, a thickness and a height. The length extends in the direction Y, the thickness extends in the direction X, and the height extends in the direction Z. The heat exchangers 24, 26, 28 thus extend on a general plane parallel to the vertical direction Z and the lateral direction Y. This general plane is thus perpendicular to the longitudinal direction X of the cooling module 22.

The cooling module 22 also comprises a first collector housing 41 positioned downstream from the set of heat exchangers 23 in the direction of circulation of the air flow. The first collector housing 41 comprises an outlet 45 for the air flow F. This first collector housing 41 thus makes it possible to recover the air flow F passing through the set of heat exchangers 23, and to orient this air flow F towards the outlet 45. The first collector housing 41 can be integral with the fairing 40 or it can be an attachment secured to the downstream end 40b of said fairing 40.

The cooling module 22, more specifically the first collector housing 41, also comprises at least one tangential-flow fan, also known as a tangential-flow turbomachine 30, which is configured so as to generate the air flow F passing through the set of heat exchangers 23. The tangential-flow turbomachine 30 comprises a rotor or turbine 32 (or tangential blower wheel). The turbine 32 has a substantially cylindrical shape. The turbine 32 advantageously comprises a plurality of stages of blades (or vanes). The turbine 32 is mounted so as to rotate around an axis of rotation A, which for example is parallel to the direction Y, as shown in FIG. 2. The diameter of the turbine 32 is for example between 35 mm and 200 mm so as to limit its size. The turbomachine 30 is thus compact.

The tangential-flow turbomachine 30 can also comprise a motor 31 (visible in FIG. 2) configured to rotate the turbine 32. The motor 31 is for example able to rotate the turbine 32 at a speed of between 200 rpm and 14,000 rpm. This notably makes it possible to limit the noise generated by the tangential-flow turbomachine 30.

The tangential-flow turbomachine 30 is positioned in the first collector housing 41. The tangential-flow turbomachine 30 is configured to aspirate air in order to generate the air flow F passing through the set of heat exchangers 23. The tangential-flow turbomachine 30 comprises more specifically a blower housing 44, formed by the first collector housing 41, at the centre of which the turbine 32 is arranged. The discharge of air from the blower housing 44 corresponds to the outlet 45 for the air flow F from the first collector housing 41.

In the example illustrated in FIGS. 2 to 5, the tangential-flow turbomachine 30 is in a high position, in particular in the upper third of the first collector housing 41, preferably in the upper quarter of the first collector housing 41. This notably makes it possible to protect the tangential-flow turbomachine 30 in the event of submersion, and/or to limit the space taken up by the cooling module 22 in its lower part. In this case, the outlet 45 for the air flow F is preferably oriented toward the lower part of the cooling module 22.

It is nevertheless conceivable for the tangential-flow turbomachine 30 to be in a low position, notably in the lower third of the first collector housing 41. This would make it possible to limit the space taken up by the cooling module 22 in its upper part. In this case, the outlet 45 for the air flow will preferably be oriented toward the upper part of the cooling module 22.

Here, upper and lower refer to an orientation in the direction Z. An element referred to as upper will be closer to the roof of the vehicle 10 and an element referred to as lower will be closer to the ground.

In order to guide the air leaving the set of heat exchangers 23 to the outlet 45, the first collector housing 41 comprises, disposed facing the downstream end 40b of the fairing 40, a guide wall 46 for guiding the air flow F to the outlet 45. This guide wall 46 more particularly adjoins an upstream edge 451 of the outlet 45 of the air flow F. Here, the term “upstream edge 451” means the edge of the outlet 45 closest to the downstream end 40b of the fairing 40.

The guide wall 46 makes an angle α with a first plane P1 perpendicular to the longitudinal direction X of the cooling module 22. This angle α is more particularly between 0° and a maximum angle of 25°, preferably 23°. If the angle α is 0°, then the guide wall 46 coincides with the perpendicular P1 to the longitudinal direction X of the cooling module 22. The maximum angle of 25° corresponds to the angle α′ of a second plane of maximum inclination P2 (visible in FIGS. 3 to 5) with the first plane P1. Preferably, the guide wall 46 is inclined and the angle α is between 5 and 25° with respect to the first plane P1.

This second plane of maximum inclination P2 more specifically connects the upstream edge 451 of the outlet 45 and a downstream end edge 230 of the at least one heat exchanger 24, 26, 28. Here, the term “downstream end edge 230” means the edge of a heat exchanger 24, 26, 28 closest to the downstream end 40b of the fairing 40. When the fairing 40 comprises several heat exchangers 24, 26, 28, the downstream end edge 230 taken into consideration is the downstream end edge 230 of the heat exchanger furthest downstream, in this case the second heat exchanger 26. The downstream end edge 230 is oriented facing the outlet 45 of the air flow F. This means that, as illustrated in FIG. 3, if the outlet 45 is oriented toward the lower part of the cooling module 22, the downstream end edge 230 is a lower end edge of the heat exchanger 26. Conversely, if the outlet 45 is oriented toward the upper part of the cooling module 22, the downstream end edge 230 will be an upper end edge of the heat exchanger 26.

The fact that the guide wall 46 makes an angle α of between 0° and 25°, and more particularly is inclined at an angle α of between 0° and 25°, allows better circulation of the air flow F within the first collector housing 41 and limits the loss of pressure.

As shown in FIGS. 3 to 5, the blower housing 44 comprises a movable outer wall 440. This outer wall 440 is movable in particular between a first end position (illustrated in FIG. 3) in which the outlet 45 of the air flow F has a first orientation, and a second end position (illustrated in FIG. 5) in which the outlet 45 of the air flow F has a second orientation different from the first orientation.

Thus by varying the position of the outer wall 440, it is possible to orient the air flow F according to the constraints within the vehicle compartment in which the cooling module 22 is to be installed. The air flow F is thus more easily discharged at the outlet from the cooling module 22, and the electricity consumption necessary to generate this air flow F, in particular by the turbine 32, is less.

The outer wall 440 can in particular be sliding. For this, the cooling module 22 can comprise lateral rails 442 for guiding the outer wall 440. These lateral rails can in particular be arranged on the inner face of the side walls 443. These side walls 443 are more particularly perpendicular to the axis of rotation A of the turbine 32.

The outer wall 440 of the blower housing 44 can for example comprise a succession of articulated, mutually parallel slats so as to form a semi-rigid curtain. The outer wall 440 of the blower housing 44 can also for example be a semi-rigid sheet impermeable to air.

In order to facilitate sliding and also limit the space required, the cooling module 22 can comprise a winding shaft 441 around which the outer wall 440 winds. This winding shaft 441 is fixed to the end of the outer wall 440 opposite its end forming the outlet 45. Thus by turning the winding shaft 441 in one direction or the other, it is possible to wind and unwind the outer wall 440 so that this slides between its first end position and its second end position.

The winding shaft 441 can more particularly be motorised. Thus it is possible to control the position of the outer wall 440 by controlling the number and direction of turns of the winding shaft 441 as required.

FIG. 3 shows an example in which the outer wall 440 is in its first end position. The first orientation of the outlet 45 for the air flow F is then perpendicular to the longitudinal direction X of the cooling module 22. In the example shown, this first orientation of the outlet 45 is downward, i.e. oriented towards the ground in the state mounted in the motor vehicle.

FIG. 4 shows an example in which the outer wall 440 is in an intermediate position situated between its first and second end positions. The outlet 45 of the air flow F is then oriented in an intermediate orientation between the first and second orientations. This intermediate orientation is here also oriented downward, as for the first orientation of the outlet 45 shown in FIG. 3. However, the angle here is not perpendicular to the longitudinal direction X of the cooling module 22. This angle here is less pronounced, and can for example be of the order of 5 to 45° relative to the longitudinal direction X of the cooling module 22. This particular angle can for example be due to the fact that the non-retracted part of the outer wall 440 retains a curved form guiding the air flow F.

FIG. 5 finally shows an example in which the outer wall 440 is in its second end position. The second orientation of the outlet 45 of the air flow F is then opposite the first orientation of said outlet 45 relative to the longitudinal direction X of the cooling module 22. This means for example that if, in its first orientation, the outlet 45 is oriented downward (as illustrated in FIG. 3), then in the second orientation, the outlet 45 will be oriented upward (as illustrated in FIG. 5). The reverse is also possible, i.e. if for example in the first orientation, the outlet 45 is oriented upward, then in the second configuration, the outlet 45 is oriented downward.

As shown in FIG. 2, the cooling module 22 can also include a second collector housing 42 located upstream of the fairing 40 and the set of heat exchangers 23, opposite the first collector housing 41. This second collector housing 42 comprises an inlet 42a for the air flow F coming from outside the vehicle 10. The inlet 42a can in particular be positioned facing the cooling opening 18. This inlet 42a can also comprise the protective grille 20. The second collector housing 42 can be integral with the fairing 40 or else be an attachment secured to the upstream end 40a of said fairing 40.

In addition, the inlet 42a of the second collector housing 42 can have a front face shut-off device (not depicted) that is able to move between a first position, known as the open position, and a second position, known as the shut-off position. This front face shut-off device is in particular configured to allow the air flow F coming from outside the vehicle 10 to pass through said inlet 42a in its open position and to block said air flow inlet 42a in its shut-off position.

The front face shut-off device can take different forms, such as, for example, the form of a plurality of flaps mounted so as to pivot between an open position and a closed position. The flaps can be mounted parallel to the Y direction. However, it is entirely possible to imagine other configurations such as, for example, flaps mounted parallel to the Z direction. The flaps illustrated are flaps of the flag type but other types of flaps such as butterfly flaps are entirely conceivable.

Thus it is clear that, because the outer wall 440 is movable, it is possible to orient the outlet 45 and the air flow F as required for improved circulation of said air flow F. This allows bypassing of any obstacles which can be present in the compartment designed to house the cooling module 22.

What is claimed is:

1. A cooling module for an electric or hybrid motor vehicle, said cooling module being intended to have an air flow passing through it and comprising:
a fairing forming an internal channel through which the air flow passes between an upstream end and a downstream end opposite each other, said fairing including at least one heat exchanger,
a first collector housing arranged downstream of the fairing in a longitudinal direction of the cooling module from a front to a rear of said cooling module, said first collector housing including a tangential-flow turbomachine configured so as to generate said air flow said tangential-flow turbomachine including a blower housing with an outlet for the air flow,
wherein the blower housing includes an outer wall which is movable between a first end position in which the outlet has a first orientation, and a second end position in which the outlet has a second orientation different from the first orientation.

2. The cooling module according to claim 1, wherein the outer wall is sliding.

3. The cooling module according to claim 1, further comprising a winding shaft around which the outer wall winds, said winding shaft being fixed at an end of the outer wall opposite its end forming the outlet.

4. The cooling module according to claim 3, wherein the winding shaft is motorized.

5. The cooling module according to claim 1, further comprising lateral rails for guiding the outer wall.

6. The cooling module according to claim 1, wherein in the first end position of the outer wall of the blower housing, the first orientation of the outlet of the air flow is perpendicular to the longitudinal direction of the cooling module.

7. The cooling module according to claim 1, wherein in the second end position of the outer wall of the blower housing, the second orientation of the outlet of the air flow is opposite the first orientation of the outlet relative to the longitudinal direction of the cooling module.

8. The cooling module according to claim 1, wherein when the outer wall of the blower housing is arranged in an intermediate position between its first and second end positions, the outlet of the air flow is oriented in an intermediate orientation between the first and second orientations.

9. The cooling module according to claim 1, wherein the outer wall of the blower housing includes a succession of articulated, mutually parallel slats.

10. The cooling module according to claim 1, wherein the outer wall of the blower housing is a semi-rigid sheet impermeable to air.
